(19) United States
(12) Patent Application Publication
(10) Pub. No.: US 2024/0037943 A1
(43) Pub. Date: Feb. 1, 2024

(54) ARTIFICIAL INTELLIGENCE SYSTEM TO AUTOMATICALLY ANALYZE ATHLETES FROM VIDEO FOOTAGE

(71) Applicants: Mikekena Richardson, Coralville, IA (US); Lannette Richardson, Baton Rouge, LA (US)

(72) Inventors: Mikekena Richardson, Coralville, IA (US); Lannette Richardson, Baton Rouge, LA (US)

(21) Appl. No.: 18/348,517

(22) Filed: Jul. 7, 2023

Related U.S. Application Data
(60) Provisional application No. 63/393,296, filed on Jul. 29, 2022.

(51) Int. Cl. G06V 20/40; G06T 7/246

(52) U.S. Cl. CPC G06V 20/42; G06V 20/46; G06T 7/246

(57) ABSTRACT

The disclosure includes a platform for analyzing athletes and generating matches between athletes and organizations. The platform receives data descriptive of an athlete. The platform analyzes, using a model, the data descriptive of the athlete to determine one or more attributes of the athlete. The platform generates, using the model, a match between the athlete and an organization based on the one or more attributes of the athlete and one or more characteristics of the organization.

### RELATED APPLICATIONS

This application claims the benefit of U.S. Provisional Application No. 63/393,296, filed Jul. 29, 2022, the entire contents of which are incorporated herein by reference.

### TECHNICAL FIELD

The disclosure relates to a platform to connect athletes with organizations based on an artificial intelligence-based analysis of the athlete.

### BACKGROUND

In the modern landscape, athletes have more opportunities than ever to benefit from their athletic prowess and fame. With this increased demand comes and increased supply of athletes, with individuals from all locations and all walks of life attempting to become the next superstar athlete. However, certain individuals are born with certain advantages in this respect. Athletes who are born to richer families, who are able to pay to attend camps set up to give high school athletes more notoriety, and who are born in locations more closely located to highly funded universities or in locations routinely scouted by those universities will have advantages over the athletes born to poorer, more rural families, despite the possibility that the less touted athlete may actually be a better athlete with more charisma.

This is only exacerbated by new college athletic rules that allow athletes to profit off of their Name, Image, and Likeness (NIL). NIL rules now allow college athletes to become spokespeople for various brands, and allow the athletes to individually profit off of those deals. However, it can be difficult for companies to understand who may fit their brand the best, and often rely on selecting the highest profile athlete at the university most popular in their particular marketing area.

### SUMMARY

In one example, the disclosure is directed to a method that includes receiving, by one or more processors, data descriptive of an athlete. The method further includes analyzing, by the one or more processors and using a model, the data descriptive of the athlete to determine one or more attributes of the athlete. The method also includes generating, by the one or more processors and using the model, a match between the athlete and an organization based on the one or more attributes of the athlete and one or more characteristics of the organization.

In another example, the disclosure is directed to a computing device comprising a memory component and one or more processors. The one or more processors are configured to receive data descriptive of an athlete. The one or more processors are further configured to analyze, using a model, the data descriptive of the athlete to determine one or more attributes of the athlete. The one or more processors are also configured to generate, using the model, a match between the athlete and an organization based on the one or more attributes of the athlete and one or more characteristics of the organization.

In another example, the disclosure is directed to a non-transitory computer-readable storage medium containing instructions. The instructions, when executed, cause one or more processors to receive data descriptive of an athlete. The instructions, when executed, further cause the one or more processors to analyze, using a model, the data descriptive of the athlete to determine one or more attributes of the athlete. The instructions, when executed, also cause the one or more processors to generate, using the model, a match between the athlete and an organization based on the one or more attributes of the athlete and one or more characteristics of the organization.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

The following drawings are illustrative of particular examples of the present disclosure and therefore do not limit the scope of the invention. The drawings are not necessarily to scale, though examples can include the scale illustrated, and are intended for use in conjunction with the explanations in the following detailed description wherein like reference characters denote like elements. Examples of the present disclosure will hereinafter be described in conjunction with the appended drawings.

FIG. 1 is a conceptual diagram illustrating a video of one or more athletes and a platform for analyzing said video, in accordance with the techniques described herein.

FIG. 2 is a block diagram illustrating a more detailed example of a computing device configured to perform the techniques described herein.

FIG. 3 is a flowchart illustrating an example process for analyzing an athlete and matching the athlete with an organization, in accordance with the techniques described herein.

### DETAILED DESCRIPTION

The following detailed description is exemplary in nature and is not intended to limit the scope, applicability, or configuration of the techniques or systems described herein in any way. Rather, the following description provides some practical illustrations for implementing examples of the techniques or systems described herein. Those skilled in the art will recognize that many of the noted examples have a variety of suitable alternatives.

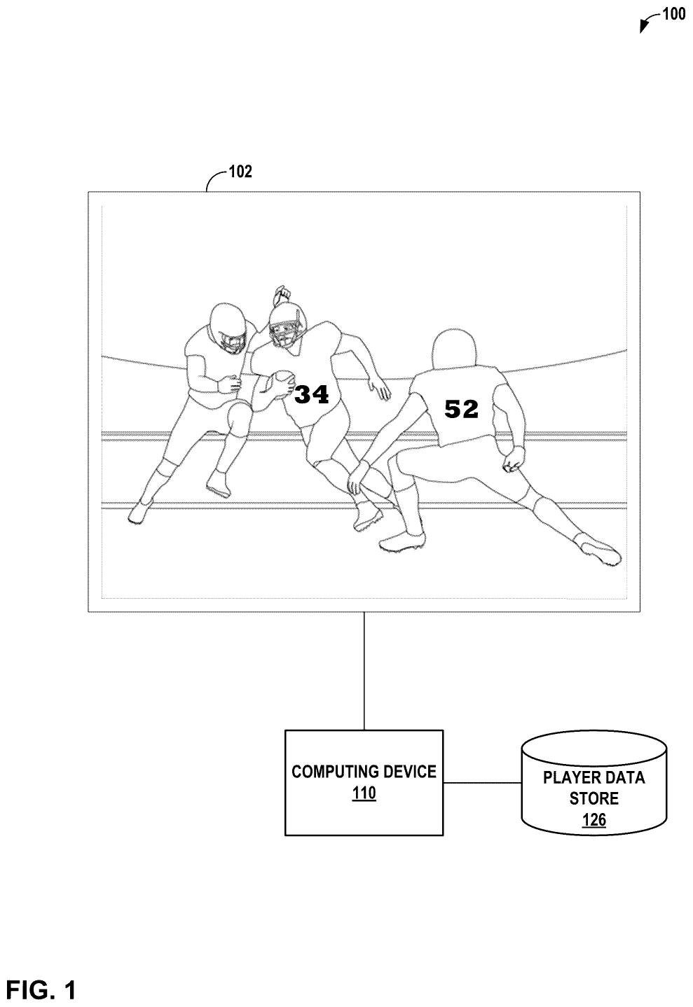

FIG. 1 is a conceptual diagram illustrating platform 100 that includes computing device 110 that may analyze video data 102 of one or more athletes, in accordance with the techniques described herein. Video data 102 may be any video footage, including practice footage, game footage, camp footage, or drill footage, that shows an athlete in action. The athletes described herein may partake in any sport, including team sports, such as football, baseball, softball, soccer, basketball, lacrosse, field hockey, ice hockey, or volleyball, among other sports, as well as individual sports, such as swimming, track and field, cross country, bowling, or other Olympic-style sports, among other sports. The athletes may also partake in sports that could be either individual or team sports, such as figure skating or tennis, among other sports. The sports described herein could also be other non-traditional sports, such as e-sports, obstacle course racing, cornhole, rugby, spikeball, pickleball, disc golf, team juggling, rock climbing, geocaching, and parkour, among other non-traditional sports. Further, organizations described herein may be any organization that could utilize the athlete's talents, including amateur teams, collegiate teams, professional teams, charitable organizations, or companies wishing to sponsor the athlete.

Computing device 110 may be any computer with the processing power required to adequately execute the techniques described herein. For instance, computing device 110 may be any one or more of a mobile computing device (e.g., a smartphone, a tablet computer, a laptop computer, etc.), a desktop computer, a smarthome component (e.g., a computerized appliance, a home security system, a control panel for home components, a lighting system, a smart power outlet, etc.), a wearable computing device (e.g., a smart watch, computerized glasses, a heart monitor, a glucose monitor, smart headphones, etc.), a virtual reality/augmented reality/extended reality (VR/AR/XR) system, a video game or streaming system, a network modem, router, or server system, or any other computerized device that may be configured to perform the techniques described herein. Computing device 110 may also include player data store 126, which may be local storage device or a cloud storage device to store one or more attributes (also referred to herein as characteristics) of various athletes using platform 100.

Computing device 110 receives data descriptive of an athlete, including video data 102 or some other inputted data, such as personality tests, aptitude tests, or manually-entered characteristics. Computing device 110 analyzes, using a model, the data descriptive of the athlete to determine one or more attributes of the athlete. Computing device 110 generates, using the model, a match between the athlete and an organization based on the one or more attributes of the athlete and one or more characteristics of the organization. Computing device 110 may present these matches to athletes and/or organizations to aid said athletes and organizations in deciding potential affiliations.

In some instances, platform 100 may execute such that an individual creates a profile for an individual athlete or an organization, saved to computing device 110. Organizations for the athlete, or athletes for the organization, may be stored on a server device, and the individual may search for athletes/organizations that fit their individual profile saved to computing device 110. In other instances, all profiles for all organizations and athletes may be stored on the server device.

Data, such as video data 102, may be uploaded to the server device, which may analyze the information. For instance, athlete 34 in video data 102 may be a running back for a high school football team. Athlete 34, or another individual, may upload game footage from a particular football game to platform 100, noting that athlete 34 was participating in the game. Computing device 110 may analyze the game footage to determine one or more attributes for athlete 34, which are added to, or updated within, a profile for athlete 34 stored in player data store 126. In other instances, computing device 110, or some other device, may scrape the internet for new videos, identify athlete 34 within those videos, and analyze the videos to add to, or update, a profile for athlete 34. Computing device 110 may utilize a number of factors in identifying athlete 34, such as a timestamp of the video (e.g., to match a data and/or time with a roster current for that date and/or time), uniform aesthetic details (e.g., to identify a team), optical character recognition (e.g., to identify a team or number for the player), and known physical characteristics of the athlete.

In some instances, when video data 102 is analyzed for athlete 34, computing device 110 may recognize other players in video data 102 using one or more of an artificial intelligence model or an image analysis model. For instance, computing device 110 may recognize athlete 52 as a linebacker for an opposing team in the game footage. Computing device 110 may determine whether game footage for athlete 52 has already been analyzed for this particular game, and, if no game footage has been analyzed, further analyze video data 102 for one or more attributes for athlete 52, even though video data 102 was initially uploaded for athlete 34. However, if game footage for this game has already been analyzed for athlete 52, computing device 110 may either refrain from analyzing video data 102 or may replace the already analyzed video data such that a single athlete does not get multiple analyses that skews their scores and attributes.

While the above example is provided using football as an example, similar techniques may be applied to other sports. For instance, computing device 110 may identify and analyze athletes in other sports, including team sports, such as baseball, softball, soccer, basketball, lacrosse, field hockey, ice hockey, or volleyball, among other sports, as well as individual sports, such as swimming, track and field, cross country, bowling, or other Olympic-style sports, among other sports. Computing device 110 may also identify and analyze athletes in sports that could be either individual or team sports, such as figure skating or tennis, among other sports. Computing device 110 may also identify and analyze other non-traditional sports, such as e-sports, obstacle course racing, cornhole, rugby, spikeball, pickleball, disc golf, team juggling, rock climbing, geocaching, and parkour, among other non-traditional sports. Further, organizations described herein may be any organization that could utilize the athlete's talents, including amateur teams, collegiate teams, professional teams, charitable organizations, or companies wishing to sponsor the athlete.

Computing device 110 may analyze the video footage to determine any number of attributes for an athlete. For instance, computing device 110 may derive a performance pattern for the athlete (e.g., performs better earlier in a game, performs better later in a game, is a streaky performer, is a consistent performer, performs in certain ways when the opposing team or player does certain things in opposition of the athlete, etc.), a performance rhythm for the athlete (e.g., a player will typically do certain actions in sequence, a player will perform in a certain way after certain other actions occur, etc.), a location on a playing surface where the athlete is successful (e.g., in the lane vs. beyond the three-point arc in basketball, in the middle of the field vs. along the sideline in football, on the left side of the ice vs. on the right side of the ice in hockey, etc.), a location on the playing surface where the athlete is unsuccessful, a body type of the athlete (e.g., burly, muscular, toned, slender, unrefined, etc.), a playing style for the athlete (e.g., speed-focused, power-focused, finesse-focused, skill-focused, balanced, etc.), speed data for the athlete (e.g., acceleration and top speed, etc.), agility data for the athlete (e.g., ability to change direction, etc.), and one or more performance metrics for the athlete (e.g., stats and results of plays, etc.).

Computing device 110 may also analyze various character traits about an athlete, including personal ethics and personal morals (e.g., a number of fouls or penalties committed by an athlete, types of fouls or penalties committed by the athlete, a level of illegal violence associated with the fouls or penalties, etc.), charisma (e.g., whether and how often a player celebrates, whether the player associates with teammates, etc.), fashion (e.g., whether the player wears accessories or jewelry, etc.), and play style (e.g., whether the athlete uses speed or power, etc.).

Computing device 110 may utilize video recognition techniques to identify the athlete, identify the playing surface, identify playing equipment, and determine various aspects of a play. For instance, computing device 110 may derive speed data based on how long it takes a player in a video to travel from one known point on the playing surface to a second known point on the playing surface, including how long it takes for a player to reach their maximum speed for that play. Computing device 110 may also analyze playing equipment to determine results of a play, such as whether a basketball shot was made, whether a baseball pitch was a ball, a strike, or a hit, or locations of serves in tennis. Based on a number of data points, computing device 110 may create or update the overall profile with the various data points, thereby enabling the system to match the various determinations about the athlete with how that athlete would fit with different organizations.

This platform may produce benefits for any number of users. For athletes, they may make a more informed decision about organizations they may be a part of, including all of universities, professional teams, or potential sponsorship companies. Certain organizations may be better fits for an athlete based on both characteristics of the athlete and characteristics of the organization, but the athlete may be unaware of those characteristics and instead choose the organization that woos them the most, regardless of fit. By utilizing this platform, the athlete may best find an organization that can utilize their talents to the fullest extent, setting the athlete up for long-term success, both with athletic teams and sponsorships. In other words, a player may receive a filtered list of options generated by the platform, where the platform only includes organizations deemed to be a “match” in a list sent to the players rather than the entire database of all organizations. This may improve the overall system by reducing network traffic and local memory usage required to handle the communicated lists.

For teams, executives may be able to better allocate scouting resources by initially finding athletes that fit the systems and play styles of the organization, as well as team needs for the organization. For instance, if a team needs a certain position on their roster (which may be evidenced by computing device 110 analyzing players currently on the roster), and they require that particular player to perform specific duties that other teams may not ask out of that position, simply going by an athlete's star rating may not be useful. Instead, an organization can utilize this platform to find athletes that would fit their specific system, and the team can then allocate scouting resources based on the more informed information only available through this platform. In other words, an organization may receive a filtered list of options generated by the platform, where the platform only includes players deemed to be a “match” in a list sent to the organization rather than the entire database of all players. This may improve the overall system by reducing network traffic and local memory usage required to handle the communicated lists. Coaches may also use this platform for scouting purposes to identify members of opposing teams and what their various athletic traits are so that coaches may prepare for players where limited film may be available.

For potential sponsor organizations, the organizations may wish to sponsor specific types of players that fit an image of their organization. The platform described herein removes the guesswork from that process, matching sponsorship organizations with athletes that fit the characteristics desired by the organization, including charisma, location, flashiness of play style, personal background, fashion both on and off the playing field, and any other number of characteristics that an organization may look for. In other words, an organization may receive a filtered list of options generated by the platform, where the platform only includes players deemed to be a “match” in a list sent to the organization rather than the entire database of all players. This may improve the overall system by reducing network traffic and local memory usage required to handle the communicated lists.

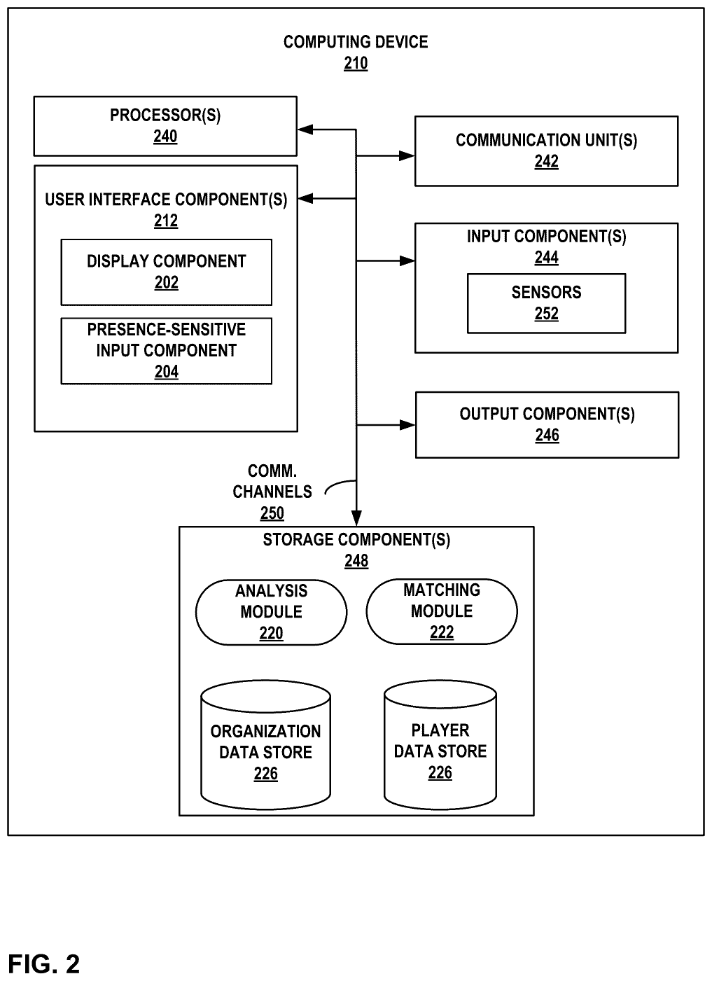

FIG. 2 is a block diagram illustrating a more detailed example of a computing device configured to perform the techniques described herein. Computing device 210 of FIG. 2 is described below as an example of computing device 110 of FIG. 1. FIG. 2 illustrates only one particular example of computing device 210, and many other examples of computing device 210 may be used in other instances and may include a subset of the components included in example computing device 210 or may include additional components not shown in FIG. 2.

Computing device 210 may be any computer with the processing power required to adequately execute the techniques described herein. For instance, computing device 210 may be any one or more of a mobile computing device (e.g., a smartphone, a tablet computer, a laptop computer, etc.), a desktop computer, a smarthome component (e.g., a computerized appliance, a home security system, a control panel for home components, a lighting system, a smart power outlet, etc.), a wearable computing device (e.g., a smart watch, computerized glasses, a heart monitor, a glucose monitor, smart headphones, etc.), a virtual reality/augmented reality/extended reality (VR/AR/XR) system, a video game or streaming system, a network modem, router, or server system, or any other computerized device that may be configured to perform the techniques described herein.

As shown in the example of FIG. 2, computing device 210 includes user interface components (UIC) 212, one or more processors 240, one or more communication units 242, one or more input components 244, one or more output components 246, and one or more storage components 248. UIC 212 includes display component 202 and presence-sensitive input component 204. Storage components 248 of computing device 210 include analysis module 220, matching module 222, organization data store 224, and player data store 226.

One or more processors 240 may implement functionality and/or execute instructions associated with computing device 210 to analyze characteristics of an athlete and match that athlete with an organization. That is, processors 240 may implement functionality and/or execute instructions associated with computing device 210 to apply a model to video data of an athlete in order to match the athlete with an organization that best fits their characteristics.

Examples of processors 240 include application processors, display controllers, auxiliary processors, one or more sensor hubs, and any other hardware configured to function as a processor, a processing unit, or a processing device. Modules 220 and 222 may be operable by processors 240 to perform various actions, operations, or functions of computing device 210. For example, processors 240 of computing device 210 may retrieve and execute instructions stored by storage components 248 that cause processors 240 to perform the operations described with respect to modules 220 and 222. The instructions, when executed by processors 240, may cause computing device 210 to apply a model to video data of an athlete in order to match the athlete with an organization that best fits their characteristics.

Analysis module 220 may execute locally (e.g., at processors 240) to provide functions associated with analyzing video data of the athlete to develop one or more characteristics about the athlete. In some examples, analysis module 220 may act as an interface to a remote service accessible to computing device 210. For example, analysis module 220 may be an interface or application programming interface (API) to a remote server that analyzes video data of the athlete to develop one or more characteristics about the athlete.

In some examples, matching module 222 may execute locally (e.g., at processors 240) to provide functions matching an athlete with an organization based on characteristics of the athlete and characteristics of the organization. In some examples, matching module 222 may act as an interface to a remote service accessible to computing device 210. For example, matching module 222 may be an interface or application programming interface (API) to a remote server that matches an athlete with an organization based on characteristics of the athlete and characteristics of the organization.

One or more storage components 248 within computing device 210 may store information for processing during operation of computing device 210 (e.g., computing device 210 may store data accessed by modules 220 and 222 during execution at computing device 210). In some examples, storage component 248 is a temporary memory, meaning that a primary purpose of storage component 248 is not long-term storage. Storage components 248 on computing device 210 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 248, in some examples, also include one or more computer-readable storage media. Storage components 248 in some examples include one or more non-transitory computer-readable storage mediums. Storage components 248 may be configured to store larger amounts of information than typically stored by volatile memory. Storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 248 may store program instructions and/or information (e.g., data) associated with modules 220 and 222, as well as data stores 224 and 226. Storage components 248 may include a memory configured to store data or other information associated with modules 220 and 222, as well as data stores 224 and 226.

Communication channels 250 may interconnect each of the components 212, 240, 242, 244, 246, and 248 for inter-component communications (physically, communicatively, and/or operatively). In some examples, communication channels 250 may include a system bus, a network connection, an inter-process communication data structure, or any other method for communicating data.

One or more communication units 242 of computing device 210 may communicate with external devices via one or more wired and/or wireless networks by transmitting and/or receiving network signals on one or more networks. Examples of communication units 242 include a network interface card (e.g., such as an Ethernet card), an optical transceiver, a radio frequency transceiver, a GPS receiver, a radio-frequency identification (RFID) transceiver, a near-field communication (NFC) transceiver, or any other type of device that can send and/or receive information. Other examples of communication units 242 may include short wave radios, cellular data radios, wireless network radios, as well as universal serial bus (USB) controllers.

One or more input components 244 of computing device 210 may receive input. Examples of input are tactile, audio, and video input. Input components 244 of computing device 210, in one example, include a presence-sensitive input device (e.g., a touch sensitive screen, a PSD), mouse, keyboard, voice responsive system, camera, microphone or any other type of device for detecting input from a human or machine. In some examples, input components 244 may include one or more sensor components (e.g., sensors 252). Sensors 252 may include one or more biometric sensors (e.g., fingerprint sensors, retina scanners, vocal input sensors/microphones, facial recognition sensors, cameras), one or more location sensors (e.g., GPS components, Wi-Fi components, cellular components), one or more temperature sensors, one or more movement sensors (e.g., accelerometers, gyros), one or more pressure sensors (e.g., barometer), one or more ambient light sensors, and one or more other sensors (e.g., infrared proximity sensor, hygrometer sensor, and the like). Other sensors, to name a few other non-limiting examples, may include a heart rate sensor, magnetometer, glucose sensor, olfactory sensor, compass sensor, or a step counter sensor.

One or more output components 246 of computing device 210 may generate output in a selected modality. Examples of modalities may include a tactile notification, audible notification, visual notification, machine generated voice notification, or other modalities. Output components 246 of computing device 210, in one example, include a presence-sensitive display, a sound card, a video graphics adapter card, a speaker, a cathode ray tube (CRT) monitor, a liquid crystal display (LCD), a light emitting diode (LED) display, an organic LED (OLED) display, a virtual/augmented/extended reality (VR/AR/XR) system, a three-dimensional display, or any other type of device for generating output to a human or machine in a selected modality.

UIC 212 of computing device 210 may include display component 202 and presence-sensitive input component 204. Display component 202 may be a screen, such as any of the displays or systems described with respect to output components 246, at which information (e.g., a visual indication) is displayed by UIC 212 while presence- sensitive input component 204 may detect an object at and/or near display component 202.

While illustrated as an internal component of computing device 210, UIC 212 may also represent an external component that shares a data path with computing device 210 for transmitting and/or receiving input and output. For instance, in one example, UIC 212 represents a built-in component of computing device 210 located within and physically connected to the external packaging of computing device 210 (e.g., a screen on a mobile phone). In another example, UIC 212 represents an external component of computing device 210 located outside and physically separated from the packaging or housing of computing device 210 (e.g., a monitor, a projector, etc. that shares a wired and/or wireless data path with computing device 210).

UIC 212 of computing device 210 may detect two-dimensional and/or three-dimensional gestures as input from a user of computing device 210. For instance, a sensor of UIC 212 may detect a user's movement (e.g., moving a hand, an arm, a pen, a stylus, a tactile object, etc.) within a threshold distance of the sensor of UIC 212. UIC 212 may determine a two or three-dimensional vector representation of the movement and correlate the vector representation to a gesture input (e.g., a hand-wave, a pinch, a clap, a pen stroke, etc.) that has multiple dimensions. In other words, UIC 212 can detect a multi-dimension gesture without requiring the user to gesture at or near a screen or surface at which UIC 212 outputs information for display. Instead, UIC 212 can detect a multi-dimensional gesture performed at or near a sensor which may or may not be located near the screen or surface at which UIC 212 outputs information for display.

In accordance with the techniques of this disclosure, analysis module 220 may receive data descriptive of an athlete. In some instances, the data descriptive of the athlete could include any one or more of statistical averages, statistical totals, advanced statistics, athlete position, athlete sport, athlete size data, academic data, and video data of the athlete. The video data may be one or more of game footage and practice footage (e.g., camp footage, drill footage, other practice situations, etc.).

Analysis module 220 may analyze, using a model, the data descriptive of the athlete to determine one or more attributes of the athlete. For instance, when the data descriptive of the athlete is video data of the athlete, analyzing the data descriptive of the athlete may include analysis module 220 performing video analysis on the video data to derive the one or more attributes of the athlete. In such instances, the one or more attributes could include any one or more of a performance pattern for the athlete, a performance rhythm for the athlete, a location on a playing surface where the athlete is successful, a location on the playing surface where the athlete is unsuccessful, a body type of the athlete, a playing style for the athlete, speed data for the athlete, agility data for the athlete, and one or more performance metrics for the athlete.

In performing the video analysis, analysis module 220 may use the model to identify the athlete in the video data. Analysis module 220 may track one or more movements of the athlete in the video data and identify a situation for the athlete throughout the one or more movements (e.g., the athlete was carrying a football, the athlete was making a defensive play on a baseball, the athlete was dribbling the ball in soccer, the athlete was attempting to break up a pass in football, the athlete was in a particular video game activity during an e-sports competition, or a success of a play, etc.). Analysis module 220 may determine the one or more attributes of the athlete based on the one or more movements and the situation.

Matching module 222 may generate, using the model, a match between the athlete and an organization based on the one or more attributes of the athlete and one or more characteristics of the organization. For instance, the organization may be a sports team, either amateur, collegiate, or professional. In such instances, the one or more characteristics of the organization may be one or more of a play style of the sports team, a projected need at the position played by athlete, a location of the sports team, an academic requirement for the sports team, athletic tendencies for the sports team, one or more attributes for players currently on the sports team, and coaching information, among other things.

As such, generating the match between the athlete and the organization may include matching module 222, based on the data descriptive of the athlete, the one or more attributes of the athlete, and the one or more characteristics of the organization, determining a fit level between the athlete and the organization. Matching module 222 may compare the fit level between the athlete and the organization to a threshold fit level. In response to the fit level between the athlete and the organization meeting the threshold fit level, matching module 222 may determine that the athlete and the organization are the match. In some examples, computing device 210 may only present matches, either directly to a user or through sending data to a client device accessing computing device 210, rather than all of the data, thereby decreasing the amount of data sent over the network, decreasing the processing done by a client device, and improving the user interface.

In instances where there are multiple organizations and the above organization is a first organization, based on the data descriptive of the athlete, the one or more attributes of the athlete, and one or more characteristics of each of a plurality of organizations including the first organization, matching module 222 may further determine a fit level between the athlete and each respective organization of the plurality of organizations. Matching module 222 may then sort a list of the plurality of organizations by the fit level for each respective organization. In instances where only a top match is provided to a user, matching module 222 may determine the match between the athlete and the first organization as the first organization having a highest fit level.

In some instances, the data descriptive of the athlete comprises a personality test. In such instances, in analyzing the data descriptive of the athlete, analysis module 220 may evaluate at least responses to the personality test, by the athlete, to determine the one or more attributes of the athlete, wherein the one or more attributes comprise one or more personality attributes of the athlete. Additionally, analysis module 220 may perform video analysis on the video data of the athlete and determine the one or more personality attributes of the athlete based on the responses to the personality test and the video analysis of the video data of the athlete, such as by whether the athlete appears to exhibit good sportsmanship, performs excessive fouls, or performs excessive celebrations. In some examples, the one or more personality attributes of the athlete may be any one or more of personal ethics, personal morals, charisma, and play style.

In some examples, the organization may be a company (e.g., a for-profit company or a charitable organization). As such, the one or more characteristics of the organization may include any one or more of a company culture, a company environment, company morals, typical consumer, product type, marketing needs, and marketing budget.

As such, generating the match between the athlete and the organization may include matching module 222, based on the data descriptive of the athlete, the one or more attributes of the athlete, and the one or more characteristics of the organization, determining a fit level between the athlete and the organization. Matching module 222 may compare the fit level between the athlete and the organization to a threshold fit level. In response to the fit level between the athlete and the organization meeting the threshold fit level, matching module 222 may determine that the athlete and the organization are the match. In some examples, computing device 210 may only present matches, either directly to a user or through sending data to a client device accessing computing device 210, rather than all of the data, thereby decreasing the amount of data sent over the network, decreasing the processing done by a client device, and improving the user interface.

In instances where there are multiple organizations and the above organization is a first organization, based on the data descriptive of the athlete, the one or more attributes of the athlete, and one or more characteristics of each of a plurality of organizations including the first organization, matching module 222 may further determine a fit level between the athlete and each respective organization of the plurality of organizations. Matching module 222 may then sort a list of the plurality of organizations by the fit level for each respective organization. In instances where only a top match is provided to a user, matching module 222 may determine the match between the athlete and the first organization as the first organization having a highest fit level.

Computing device 210 may also provide search functions. For instance, matching module 222 may receive an indication of user input from the athlete to search a plurality of organizations, including the first organization, to match with at least one of the plurality of organizations. Similarly, matching module 222 may receive an indication of user input from a user associated with the organization to search a plurality of athletes, including the first athlete, to match with at least one of the plurality of athletes.

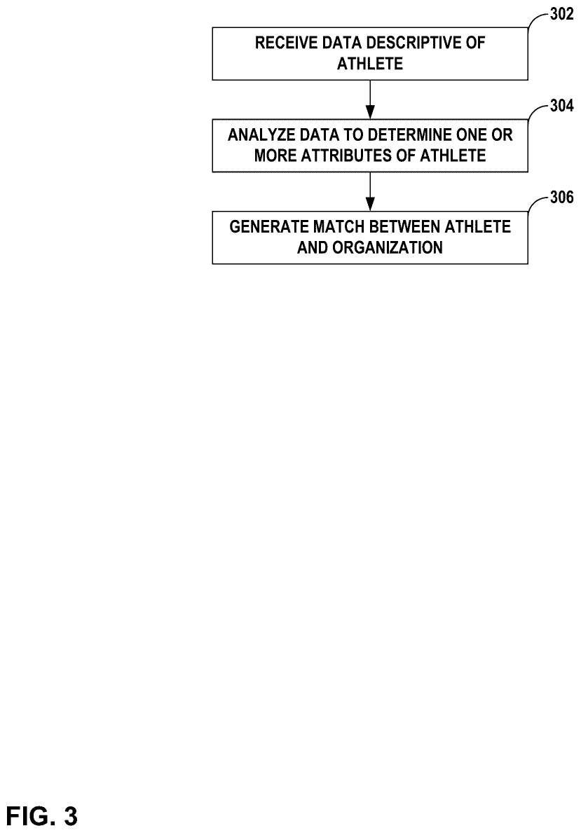

FIG. 3 is a flow chart illustrating an example mode of operation. The techniques of FIG. 3 may be performed by one or more processors of a computing device, such as system 100 of FIG. 1 and/or computing device 210 illustrated in FIG. 2. For purposes of illustration only, the techniques of FIG. 3 are described within the context of computing device 210 of FIG. 2, although computing devices having configurations different than that of computing device 210 may perform the techniques of FIG. 3.

In accordance with the techniques described herein, analysis module 220 receives data descriptive of an athlete (302). Analysis module 220 analyzes, using a model, the data descriptive of the athlete to determine one or more attributes of the athlete (304). Matching module 222 generates, using the model, a match between the athlete and an organization based on the one or more attributes of the athlete and one or more characteristics of the organization (306).

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples of the disclosure have been described. Any combination of the described systems, operations, or functions is contemplated. These and other examples are within the scope of the following claims.

What is claimed is:

1. A method comprising:
receiving, by one or more processors, data descriptive of an athlete;
analyzing, by the one or more processors and using a model, the data descriptive of the athlete to determine one or more attributes of the athlete; and
generating, by the one or more processors and using the model, a match between the athlete and an organization based on the one or more attributes of the athlete and one or more characteristics of the organization.

2. The method of claim 1, wherein the data descriptive of the athlete comprises one or more of statistical averages, statistical totals, advanced statistics, athlete position, athlete sport, athlete size data, academic data, and video data of the athlete.

3. The method of claim 2, wherein the data descriptive of the athlete comprises the video data of the athlete, and wherein analyzing the data descriptive of the athlete comprises:
performing, by the one or more processors, video analysis on the video data to derive the one or more attributes of the athlete.

4. The method of claim 3, wherein the one or more attributes comprise a performance pattern for the athlete, a performance rhythm for the athlete, a location on a playing surface where the athlete is successful, a location on the playing surface where the athlete is unsuccessful, a body type of the athlete, a playing style for the athlete, speed data for the athlete, agility data for the athlete, and one or more performance metrics for the athlete.

5. The method of claim 3, wherein performing the video analysis comprises, using the model:
identifying, by the one or more processors, the athlete in the video data;
tracking, by the one or more processors, one or more movements of the athlete in the video data;
identifying, by the one or more processors, a situation for the athlete throughout the one or more movements; and
determining, by the one or more processors, the one or more attributes of the athlete based on the one or more movements and the situation.

6. The method of claim 2, wherein the video data comprises one or more of game footage and practice footage.

7. The method of claim 2,
wherein the organization comprises a sports team,
wherein the one or more characteristics of the organization comprise one or more of a play style of the sports team, a projected need at the position played by athlete, a location of the sports team, an academic requirement for the sports team, athletic tendencies for the sports team, one or more attributes for players currently on the sports team, and coaching information, and
wherein generating the match between the athlete and the organization comprises:
based on the data descriptive of the athlete, the one or more attributes of the athlete, and the one or more characteristics of the organization, determining, by the one or more processors, a fit level between the athlete and the organization.

8. The method of claim 7, further comprising:
comparing, by the one or more processors, the fit level between the athlete and the organization to a threshold fit level; and
in response to the fit level between the athlete and the organization meeting the threshold fit level, determining, by the one or more processors, that the athlete and the organization are the match.

9. The method of claim 7, wherein the organization comprises a first organization, the method further comprising:
based on the data descriptive of the athlete, the one or more attributes of the athlete, and one or more characteristics of each of a plurality of organizations including the first organization, determining, by the one or more processors, a fit level between the athlete and each respective organization of the plurality of organizations; and
sorting, by the one or more processors, a list of the plurality of organizations by the fit level for each respective organization.

10. The method of claim 9, further comprising:
determining, by the one or more processors, the match between the athlete and the first organization as the first organization having a highest fit level.

11. The method of claim 1, wherein the athlete comprises a first athlete, the method further comprising:
receiving, by the one or more processors, an indication of user input from a user associated with the organization to search a plurality of athletes, including the first athlete, to match with at least one of the plurality of athletes.

12. The method of claim 1, wherein the data descriptive of the athlete comprises a personality test, and wherein analyzing the data descriptive of the athlete comprises:
evaluating, by the one or more processors, at least responses to the personality test, by the athlete, to determine the one or more attributes of the athlete, wherein the one or more attributes comprise one or more personality attributes of the athlete.

13. The method of claim 12, wherein determining the one or more personality attributes further comprises:
performing, by the one or more processors, video analysis on the video data of the athlete; and
determining, by the one or more processors, the one or more personality attributes of the athlete based on the responses to the personality test and the video analysis of the video data of the athlete.

14. The method of claim 12, wherein the one or more personality attributes of the athlete comprise one or more of personal ethics, personal morals, charisma, fashion, and play style.

15. The method of claim 11, wherein the organization comprises a company,
wherein the one or more characteristics of the organization comprise one or more of a company culture, a company environment, company morals, typical consumer, product type, marketing needs, and marketing budget, and
wherein generating the match between the athlete and the organization comprises:
based on the data descriptive of the athlete, the one or more attributes of the athlete, and the one or more characteristics of the organization, determining, by the one or more processors, a fit level between the athlete and the organization.

16. The method of claim 15, further comprising:
comparing, by the one or more processors, the fit level between the athlete and the organization to a threshold fit level; and
in response to the fit level between the athlete and the organization meeting the threshold fit level, determining, by the one or more processors, that the athlete and the organization are the match.

17. The method of claim 15, wherein the organization comprises a first organization, the method further comprising:
based on the data descriptive of the athlete, the one or more attributes of the athlete, and one or more characteristics of each of a plurality of organizations including the first organization, determining, by the one or more processors, a fit level between the athlete and each respective organization of the plurality of organizations; and
sorting, by the one or more processors, a list of the plurality of organizations by the fit level for each respective organization.

18. The method of claim 1, wherein the organization comprises a first organization, the method further comprising:
receiving, by the one or more processors, an indication of user input from the athlete to search a plurality of organizations, including the first organization, to match with at least one of the plurality of organizations.

19. A non-transitory computer-readable storage medium having stored thereon instructions that, when executed, cause one or more processors of a computing device to:
receive data descriptive of an athlete;
analyze, using a model, the data descriptive of the athlete to determine one or more attributes of the athlete; and
generate, using the model, a match between the athlete and an organization based on the one or more attributes of the athlete and one or more characteristics of the organization.

20. A computing device comprising:
a memory component; and
one or more processors configured to:
receive data descriptive of an athlete;
analyze, using a model, the data descriptive of the athlete to determine one or more attributes of the athlete; and
generate, using the model, a match between the athlete and an organization based on the one or more attributes of the athlete and one or more characteristics of the organization.
